(19) United States
(12) Patent Application Publication
(10) Pub. No.: US 2025/0073640 A1
(43) Pub. Date: Mar. 6, 2025

(54) EXHAUST GAS PURIFICATION DEVICE

(71) Applicants: Seiji NAKAHIGASHI, Toyota-shi (JP); Koji SUGIURA, Toyota-shi (JP); Eiji HARADA, Hamamatsu-shi (JP); Masatoshi IKEBE, Iwata-shi (JP); Takaya OTA, Fukuroi-shi (JP); Takeshi MORISHIMA, Hamamatsu-shi (JP); Ayano KIMURA, Hamamatsu-shi (JP)

(72) Inventors: Seiji NAKAHIGASHI, Toyota-shi (JP); Koji SUGIURA, Toyota-shi (JP); Eiji HARADA, Hamamatsu-shi (JP); Masatoshi IKEBE, Iwata-shi (JP); Takaya OTA, Fukuroi-shi (JP); Takeshi MORISHIMA, Hamamatsu-shi (JP); Ayano KIMURA, Hamamatsu-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 18/806,334

(22) Filed: Aug. 15, 2024

(30) Foreign Application Priority Data
Aug. 31, 2023 (JP) 2023-141358

(51) Int. Cl. B01D 53/88

(52) U.S. Cl. CPC B01D 53/885; B01D 2255/9155; B01D 2255/9205

(57) ABSTRACT

An exhaust gas purification device capable of reducing pressure loss and improving exhaust gas purification performance. Exhaust gas purification device including honeycomb substrate and outflow cell side catalyst. Honeycomb substrate includes porous partition wall defining plurality of cells extending from inflow side end surface to outflow side end surface. Plurality of cells include inflow and outflow cells adjacent across partition wall. Inflow cell has open inflow and sealed outflow side ends. Outflow cell side catalyst is disposed in inner region of partition wall at outflow cell side in outflow cell side catalyst-disposed range extending from outflow side end of partition wall to position apart by predetermined distance along extending direction. Minimum value of porosity in thickness direction of outflow cell side catalyst-disposed wall including outflow cell side catalyst-disposed range of partition wall and outflow cell side catalyst in range of 20% or more and 30% or less.

### CROSS REFERENCE TO RELATED APPLICATIONS

The present application claims priority from Japanese patent application JP 2023-141358 filed on Aug. 31, 2023, the entire content of which is hereby incorporated by reference into this application.

### BACKGROUND

### Description of Related Art

The present disclosure relates to an exhaust gas purification device that includes a catalyst in a filter comprising a wall flow structure.

### Background Art

An exhaust gas discharged from an internal combustion engine in, for example, an automobile contains a Particulate Matter (PM, hereinafter abbreviated as “PM” in some cases) mainly containing carbon, which causes air pollution, an ash as a non-combustible component, and the like. As a filter to trap and remove the PM from the exhaust gas, a filter comprising a wall flow structure has been widely used.

The filter comprising the wall flow structure usually includes a honeycomb substrate. The honeycomb substrate includes a porous partition wall defining a plurality of cells extending from an inflow side end surface to an outflow side end surface, and the plurality of cells include inflow cells and outflow cells adjacent across the partition wall. The inflow cell has an open inflow side end and a sealed outflow side end, and the outflow cell has a sealed inflow side end and an open outflow side end. In view of this, the exhaust gas flowed into the inflow cell from the inflow side end passes through the partition wall to flow into the outflow cell, thus being discharged from the outflow side end of the outflow cell. When the exhaust gas passes through the partition wall, the PM is accumulated in pores present in the partition wall. As examples of the filter comprising the wall flow structure, a diesel particulate filter (DPF) for diesel engine and a gasoline particulate filter (GPF, hereinafter abbreviated as “GPF” in some cases) for gasoline engine have been known.

Meanwhile, in addition to the PM, the exhaust gas contains harmful components, such as carbon monoxide (CO), hydrocarbons (HC), and nitrogen oxides (NOx). The harmful components can be removed from the exhaust gas by a catalyst that is disposed at a partition wall of a filter and contains a catalyst metal. Recently, to remove both of the PM and the harmful components from the exhaust gas, an exhaust gas purification device including a catalyst in a filter has been used.

As such an exhaust gas purification device, to achieve both of ensuring the exhaust gas purification performance and suppressing the PM capture rate reduction and suppressing the pressure loss, there has been known a device including a catalyst appropriately disposed in an inner region or on a surface in a cell side of a partition wall at an inflow side portion and an outflow side portion of the partition wall. For example, JP 2016-78016 A discloses an exhaust gas purification device including an upstream catalyst layer and a downstream catalyst layer. The upstream catalyst layer is provided inside a partition wall and disposed in an upstream portion (inflow side portion) of a substrate including an exhaust gas inflow end section. The downstream catalyst layer is provided inside the partition wall and disposed in a downstream portion (outflow side portion) of the substrate including an exhaust gas outflow end section. The upstream catalyst layer and the downstream catalyst layer each contain at least one noble metal (catalyst metal) from among Pt, Pd and Rh, and the noble metal included in the upstream catalyst layer and the noble metal included in the downstream catalyst layer are different from each other. With this device, the exhaust gas purification performance can be significantly improved while attempting reduction of a pressure loss with the catalyst disposed at the inner region on the cell side of the partition wall.

### SUMMARY

Conventionally, in the exhaust gas purification devices provided with the catalyst in the filter, for example, as the exhaust gas purification device described in JP 2016-78016 A, it has been attempted to improve the pressure loss and the property of purification performance with the appropriate structure in which the catalyst is disposed at the inner region in the cell side of the partition wall. Meanwhile, in recent years, in response to fuel economy regulations that are becoming stricter than before in various regions around the world, various efforts are being made for internal combustion engines in addition to electrification. One of the efforts is reduction of exhaust amount, and the need for improving the output per exhaust amount increases the requirement to reduce a back-pressure in an exhaust system. In such a situation, it is desired to more reduce the pressure loss while the exhaust gas purification performance and the PM trap performance are maintained. However, in the conventional structure in which the catalyst is disposed at the inner region in the cell side of the partition wall, the pressure loss reduction is insufficient.

The present disclosure is made in consideration of the above-described problem, and provides an exhaust gas purification device capable of reducing a pressure loss and capable of improving an exhaust gas purification performance.

To solve the above-described problem, an exhaust gas purification device of the present disclosure comprises a honeycomb substrate and an outflow cell side catalyst. The honeycomb substrate includes a porous partition wall that defines a plurality of cells extending from an inflow side end surface to an outflow side end surface. The plurality of cells include an inflow cell and an outflow cell adjacent across the partition wall. The inflow cell has an open inflow side end and a sealed outflow side end. The outflow cell has a sealed inflow side end and an open outflow side end. The outflow cell side catalyst is disposed in an inner region of the partition wall on the outflow cell side in an outflow cell side catalyst-disposed range extending from an outflow side end of the partition wall to a position apart from the outflow side end by a predetermined distance along an extending direction of the partition wall. A minimum value of a porosity in a thickness direction of an outflow cell side catalyst-disposed wall including the outflow cell side catalyst-disposed range of the partition wall and the outflow cell side catalyst is in a range of 20% or more and 30% or less.

### Effect

The exhaust gas purification device of the present disclosure can reduce the pressure loss and can improve the exhaust gas purification performance.

### BRIEF DESCRIPTION OF THE DRAWINGS

FIG. 1 is a perspective view schematically illustrating an exhaust gas purification device according to a first embodiment;

FIG. 2 is a cross-sectional view schematically illustrating a main part of a cross section parallel to a cell extending direction of the exhaust gas purification device according to the first embodiment;

FIG. 3 is a cross-sectional view schematically illustrating a main part of a cross section parallel to a cell extending direction of an exhaust gas purification device according to a second embodiment;

FIG. 4 is a cross-sectional view schematically illustrating a main part of a cross section parallel to a cell extending direction of an exhaust gas purification device according to a third embodiment;

FIG. 5 is a cross-sectional image by X-ray CT indicating a region between adjacent corners of an inflow cell in a cross section perpendicular to an extending direction at a reference position of an outflow cell side catalyst-disposed wall according to an exhaust gas purification device of Example 1;

FIG. 6 is a flowchart illustrating a procedure of obtaining a minimum value of a porosity in a thickness direction at the reference position in the extending direction of the outflow cell side catalyst-disposed wall;

FIG. 7 is a cross-sectional image indicating a cross section perpendicular to the extending direction at one photographing position (reference position) in a reference region of the outflow cell side catalyst-disposed wall according to the exhaust gas purification device of Example 1; and

FIG. 8 is a graph illustrating a relation of an initial pressure loss, and a highest NOx conversion rate to the minimum value of the porosity in the thickness direction at the reference position in the extending direction of the outflow cell side catalyst-disposed wall obtained in exhaust gas purification devices of Examples 1 and 2, and Comparative Examples 1 to 4.

### DETAILED DESCRIPTION OF THE EMBODIMENTS

The following describes an embodiment according to an exhaust gas purification device of the present disclosure.

An exhaust gas purification device according to the embodiment includes a honeycomb substrate and an outflow cell side catalyst. The honeycomb substrate includes a porous partition wall that defines a plurality of cells extending from an inflow side end surface to an outflow side end surface. The plurality of cells include an inflow cell and an outflow cell adjacent across the partition wall. The inflow cell has an open inflow side end and a sealed outflow side end. The outflow cell has a sealed inflow side end and an open outflow side end. The outflow cell side catalyst is disposed in an inner region of the partition wall on the outflow cell side in an outflow cell side catalyst-disposed range extending from an outflow side end of the partition wall to a position apart from the outflow side end by a predetermined distance along an extending direction of the partition wall. A minimum value of a porosity in a thickness direction of an outflow cell side catalyst-disposed wall including the outflow cell side catalyst-disposed range of the partition wall and the outflow cell side catalyst is in a range of 20% or more and 30% or less.

In the exhaust gas purification device according to the embodiment, the “inflow side” means a side from which an exhaust gas flows in of the exhaust gas purification device, and the “outflow side” means a side from which the exhaust gas flows out of the exhaust gas purification device. The “extending direction of the partition wall” means a direction in which the partition wall extends. The honeycomb substrate has an axial direction usually approximately same as the extending direction of the partition wall, and an extending direction of cell (direction in which the cell extends) is usually approximately same as the extending direction of the partition wall. A “thickness direction of the partition wall” means a direction perpendicular to a surface of the partition wall on the cell (inflow cell and outflow cell) side of the partition wall. A “width direction of the partition wall” means a direction perpendicular to both of the extending direction and the thickness direction of the partition wall. In the following description, an “extending direction” means the extending direction of the partition wall, and a direction approximately same as the axial direction of the honeycomb substrate and extending direction of the cell. A “thickness direction” means the thickness direction of the partition wall. A “width direction” means the width direction of the partition wall.

First, an outline of the exhaust gas purification device according to the embodiment will be described with examples of the exhaust gas purification device according to first to third embodiments.

### First Embodiment

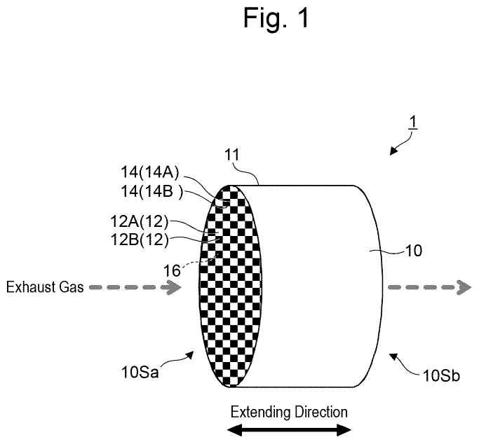

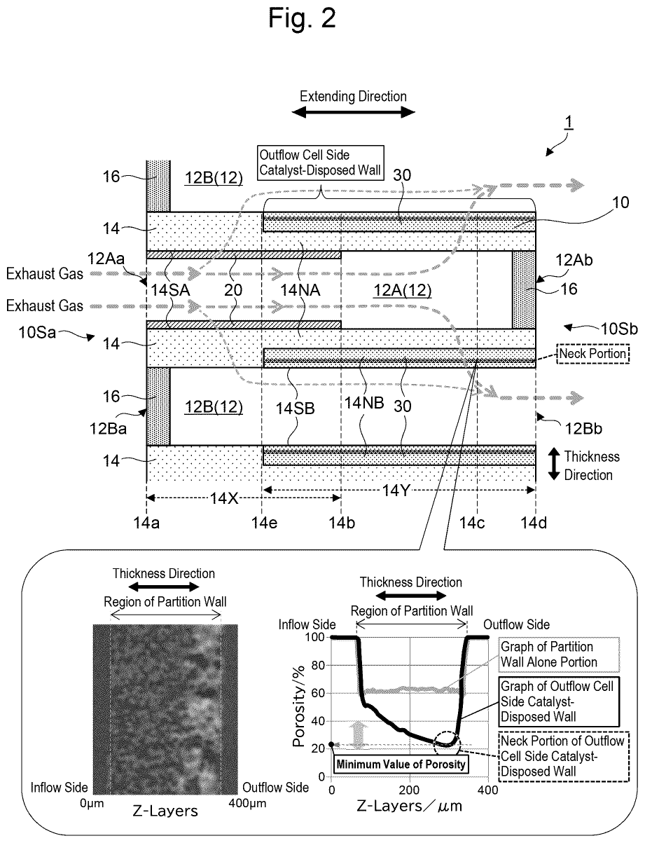

FIG. 1 is a perspective view schematically illustrating the exhaust gas purification device according to the first embodiment. FIG. 2 is a cross-sectional view schematically illustrating a main part of a cross section parallel to the cell extending direction of the exhaust gas purification device according to the first embodiment.

As illustrated in FIG. 1 and FIG. 2, an exhaust gas purification device 1 according to the first embodiment includes a honeycomb substrate 10, scaling portions 16, an inflow cell side catalyst 20, and an outflow cell side catalyst 30. The honeycomb substrate 10 is a substrate in which a cylindrical-shaped frame portion 11 and a partition wall 14 partitioning a space inside the frame portion 11 into a honeycomb shape are integrally formed. The partition wall 14 is a porous body that defines a plurality of cells 12 extending from an inflow side end surface 10Sa to an outflow side end surface 10Sb of the honeycomb substrate 10. The partition wall 14 includes a plurality of wall portions 14A arranged mutually spaced and parallel and a plurality of wall portions 14B orthogonal to the plurality of wall portions 14A and arranged mutually spaced and parallel such that cross-sectional surfaces perpendicular to the extending direction of the plurality of cells 12 have rectangular shapes. A cross-sectional surface of the partition wall 14 perpendicular to the extending direction has a grid shape.

The plurality of cells 12 include inflow cells 12A and outflow cells 12B adjacent across the partition wall 14. The inflow cell 12A has an open inflow side end 12Aa and an outflow side end 12Ab sealed by the sealing portion 16. The outflow cell 12B has an inflow side end 12Ba scaled by the sealing portion 16 and an open outflow side end 12Bb. The inflow cell 12A and the outflow cell 12B have rectangular cross sections with four corners perpendicular to the extending direction.

The inflow cell side catalyst 20 is disposed on a partition wall surface 14SA on the inflow cell 12A side in an inflow cell side catalyst-disposed range 14X extending from an inflow side end 14a of the partition wall 14 to a position 14b apart from the inflow side end 14a toward the outflow side along the extending direction by a distance of 50% of a length in the extending direction of the partition wall 14. The inflow cell side catalyst 20 includes a carrier in powder form, catalyst metal particles containing platinum (Pt) or palladium (Pd) supported on the carrier, and an OSC material.

The outflow cell side catalyst 30 is disposed in pores present in a inner region of the partition wall 14NB on the outflow cell 12B side in an outflow cell side catalyst-disposed range 14Y extending from an outflow side end 14d of the partition wall 14 to a position 14c apart from the outflow side end 14d toward the inflow side along the extending direction by a distance of 70% of the length in the extending direction of the partition wall 14. The outflow cell side catalyst 30 includes a carrier in powder form, catalyst metal particles containing rhodium (Rh) supported on the carrier, and an OSC material.

The outflow cell side catalyst-disposed wall is a wall including the outflow cell side catalyst-disposed range 14Y of the partition wall 14 and the outflow cell side catalyst 30. A reference position 14c in the extending direction of the outflow cell side catalyst-disposed wall is a position at the outflow side in a range not overlapping with an arrangement region of the sealing portion 16 in the extending direction. In a balloon of FIG. 2, a part of a cross-sectional image taken by an X-ray CT of a region between adjacent corners of the inflow cell 12A (outflow cell 12B) in a cross section perpendicular to the extending direction at the reference position 14c of the outflow cell side catalyst-disposed wall is illustrated. Together with a part of the cross-sectional image, a graph for describing a change of a porosity in a thickness direction (Z-direction) at the reference position 14c in the extending direction of the outflow cell side catalyst-disposed wall (porosity in the thickness direction of the outflow cell side catalyst-disposed wall) is illustrated.

As illustrated in the balloon of FIG. 2, the porosity in the thickness direction at the reference position 14c in the extending direction of the outflow cell side catalyst-disposed wall has a minimum value (minimum value of the porosity in the thickness direction of the outflow cell side catalyst-disposed wall) in a range of 20% or more and 30% or less. The minimum value of the porosity in the thickness direction at the reference position 14c in the extending direction of the outflow cell side catalyst-disposed wall is specifically a minimum value of a porosity (proportion of pores) at each position in the thickness direction in a reference region of the outflow cell side catalyst-disposed wall while comprising a region between adjacent corners of the inflow cell 12A (outflow cell 12B) in a range of +1 mm in the extending direction from the reference position 14c of the outflow cell side catalyst-disposed wall as the reference region. A portion in which the porosity in the thickness direction at the reference position 14c in the extending direction of the outflow cell side catalyst-disposed wall has the minimum value (portion in which the porosity in the thickness direction of the outflow cell side catalyst-disposed wall has the minimum value) is referred to as a “neck portion” in some cases.

In an exhaust gas purification device different from the exhaust gas purification device 1 according to the first embodiment in that the porosity in the thickness direction at the reference position 14c of the outflow cell side catalyst-disposed wall has the minimum value of less than 20%, when the exhaust gas pass through the outflow cell side catalyst-disposed wall from the inflow cell 12A side to the outflow cell 12B side in the thickness direction, the exhaust gas is possibly hindered from passing through at the neck portion in which the porosity in the thickness direction at the reference position 14c of the outflow cell side catalyst-disposed wall has the minimum value (less than 20%). This possibly remarkably increases the pressure loss. In addition, the excessively low porosity of the outflow cell side catalyst-disposed wall causes the insufficient contact frequency of the exhaust gas with the outflow cell side catalyst 30, and consequently, the exhaust gas purification performance in a gas diffusion limited region possibly decreases.

On the other hand, in an exhaust gas purification device different from the exhaust gas purification device 1 according to the first embodiment in that the porosity in the thickness direction at the reference position 14c of the outflow cell side catalyst-disposed wall has the minimum value of exceeding 30%, due to the insufficient amount of the outflow cell side catalyst 30 disposed at the outflow cell side catalyst-disposed wall, when the exhaust gas pass through the outflow cell side catalyst-disposed wall, the insufficient contact frequency of the exhaust gas with the outflow cell side catalyst 30 possibly causes remarkable reduction of the exhaust gas purification performance in the gas diffusion limited region.

In contrast, in the exhaust gas purification device 1 according to the first embodiment, the porosity in the thickness direction at the reference position 14c of the outflow cell side catalyst-disposed wall has the minimum value of 20% or more. Therefore, when the exhaust gas pass through the outflow cell side catalyst-disposed wall from the inflow cell 12A side to the outflow cell 12B side in the thickness direction, the exhaust gas is not hindered from passing through in the whole region including the neck portion in the thickness direction of the outflow cell side catalyst-disposed wall. Accordingly the remarkable increase of the pressure loss can be avoided. In addition, since the porosity of the outflow cell side catalyst-disposed wall is not excessively low, the contact frequency of the exhaust gas with the outflow cell side catalyst 30 does not become insufficient, and the reduction of the exhaust gas purification performance in the gas diffusion limited region can be avoided. Furthermore, the minimum value of the porosity in the thickness direction at the reference position 14c in the outflow cell side is 30% or less. Therefore, since the amount of the outflow cell side catalyst 30 disposed at the outflow cell side catalyst-disposed wall is sufficient, when the exhaust gas pass through the outflow cell side catalyst-disposed wall, the exhaust gas is brought in contact with the outflow cell side catalyst 30 with the sufficient frequency. Accordingly, the remarkable reduction of the exhaust gas purification performance in the gas diffusion limited region can be avoided.

### Second Embodiment

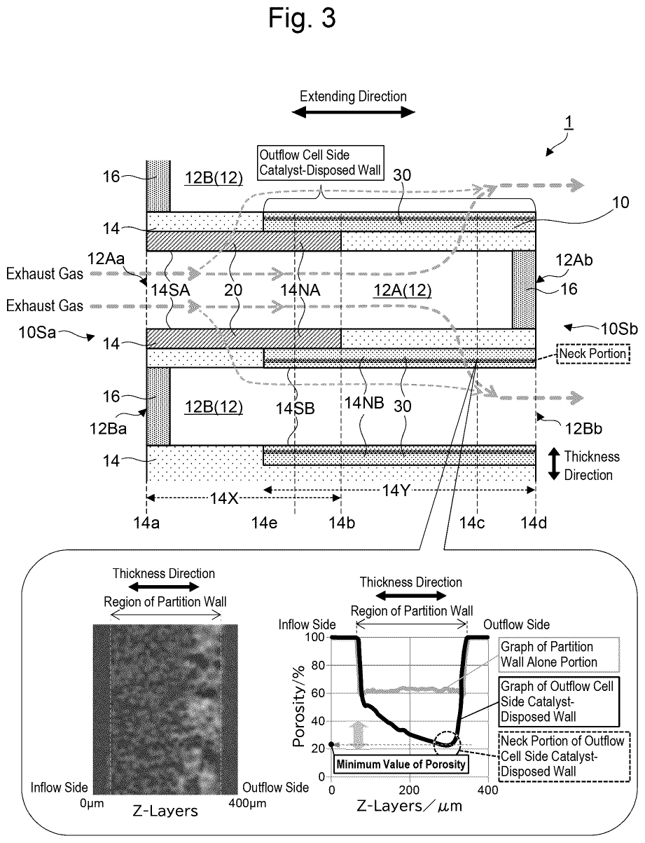

FIG. 3 is a cross-sectional view schematically illustrating a main part of a cross section parallel to a cell extending direction of an exhaust gas purification device according to a second embodiment.

As illustrated in FIG. 3, an exhaust gas purification device 1 according to the second embodiment includes, in addition to the honeycomb substrate 10, the sealing portions 16, and the outflow cell side catalyst 30 similar to those of the first embodiment, an inflow cell side catalyst 20 different from that of the first embodiment. The inflow cell side catalyst 20 is disposed in an inner region of the partition wall 14NA on the inflow cell 12A side in the inflow cell side catalyst-disposed range 14X similar to that of the first embodiment of the partition wall 14. The inflow cell side catalyst 20 includes a carrier in powder form, catalyst metal particles containing platinum (Pt) or palladium (Pd) supported on the carrier, and an OSC material. Also in this exhaust gas purification device 1, since the honeycomb substrate 10 and the outflow cell side catalyst 30 similar to those of the first embodiment are provided, similarly to the first embodiment, the porosity in the thickness direction at the reference position 14c in the extending direction of the outflow cell side catalyst-disposed wall has the minimum value in a range of 20% or more and 30% or less. Therefore, similarly to the first embodiment, when the exhaust gas pass through the outflow cell side catalyst-disposed wall from the inflow cell 12A side to the outflow cell 12B side in the thickness direction, the exhaust gas is not hindered from passing through in the whole region including the neck portion in the thickness direction of the outflow cell side catalyst-disposed wall, and the exhaust gas is brought in contact with the outflow cell side catalyst 30 with the sufficient frequency. Accordingly, the remarkable increase of the pressure loss can be avoided, and the remarkable reduction of the exhaust gas purification performance in the gas diffusion limited region can be avoided.

### Third Embodiment

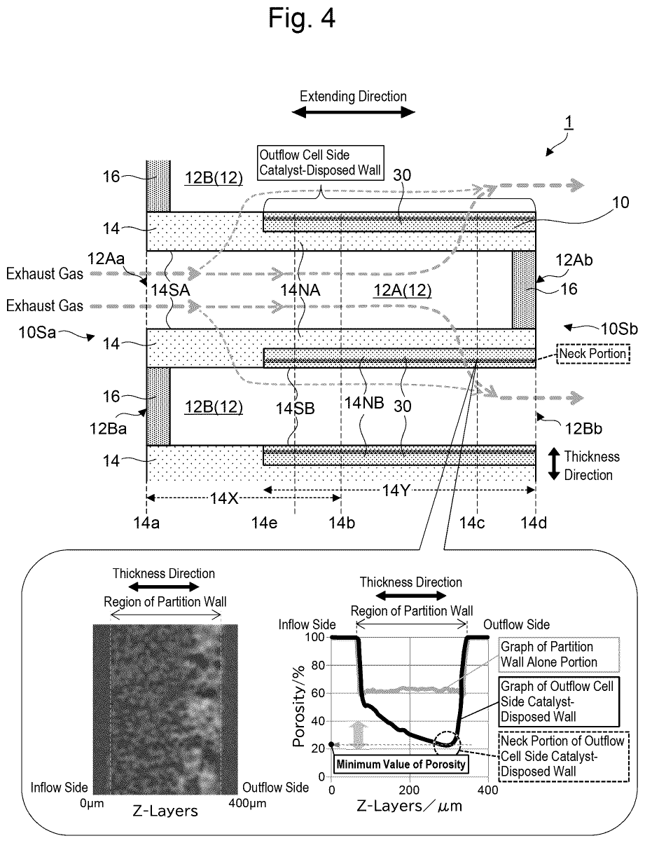

FIG. 4 is a cross-sectional view schematically illustrating a main part of a cross section parallel to a cell extending direction of an exhaust gas purification device according to a third embodiment.

As illustrated in FIG. 4, while an exhaust gas purification device 1 according to the third embodiment includes the honeycomb substrate 10, the sealing portions 16, and the outflow cell side catalyst 30 similar to those of the first embodiment, the exhaust gas purification device 1 according to the third embodiment is different from that of the first embodiment in that the inflow cell side catalyst 20 is not provided. Also in this exhaust gas purification device 1, since the honeycomb substrate 10 and the outflow cell side catalyst 30 similar to those of the first embodiment are provided, similarly to the first embodiment, the porosity in the thickness direction at the reference position 14c in the extending direction of the outflow cell side catalyst-disposed wall has the minimum value in a range of 20% or more and 30% or less. Therefore, similarly to the first embodiment, when the exhaust gas pass through the outflow cell side catalyst-disposed wall from the inflow cell 12A side to the outflow cell 12B side in the thickness direction, the exhaust gas is not hindered from passing through in the whole region including the neck portion in the thickness direction of the outflow cell side catalyst-disposed wall, and the exhaust gas is brought in contact with the outflow cell side catalyst 30 with the sufficient frequency. Accordingly, the remarkable increase of the pressure loss can be avoided, and the remarkable reduction of the exhaust gas purification performance in the gas diffusion limited region can be avoided.

Accordingly, for example, as described in the first to the third embodiments, the exhaust gas purification devices according to the embodiments can reduce the pressure loss, and can improve the exhaust gas purification performance. Subsequently, each of the configurations of the exhaust gas purification devices according to the embodiments will be described in detail.

### 1. Honeycomb Substrate

The honeycomb substrate includes the porous partition wall defining the plurality of cells extending from the inflow side end surface to the outflow side end surface. The plurality of cells include the inflow cells and the outflow cells adjacent across the partition wall. The inflow cell has the open inflow side end and the sealed outflow side end, and the outflow cell has the sealed inflow side end and the open outflow side end. The honeycomb substrate is what is called a wall flow type honeycomb substrate, and is a substrate in which the frame portion and the partition wall partitioning the space inside the frame portion into the honeycomb shape are integrally formed.

An axial length of the honeycomb substrate is not specifically limited and a general length can be used. For example, the length may be in a range of 10 mm or more and 500 mm or less, and may be in a range of 50 mm or more and 300 mm or less. A capacity of the honeycomb substrate, namely, a total volume of the cells is not specifically limited and a general capacity can be used. For example, the capacity may be in a range of 0.1 L or more and 5 L or less.

While a material of the honeycomb substrate is not specifically limited and a general material can be used, examples of the material include, a ceramic, such as cordierite, silicon carbide (SiC), and aluminum titanate, and an alloy, such as a stainless steel.

While a shape of the frame portion is not specifically limited and a general shape can be used, examples of the shape include a tubular shape, such as an elliptical cylindrical shape and a polygonal cylindrical shape, in addition to a cylindrical shape. Other configurations of the frame portion are not specifically limited, and general configurations can be used.

A shape of the partition wall is not specifically limited, and a general shape can be used. Usually, as described in the first embodiment, the partition wall includes a plurality of wall portions arranged mutually spaced and parallel and extending in the extending direction and a plurality of other wall portions intersecting with the plurality of wall portions and extending in the extending direction to be arranged mutually spaced and parallel such that cross-sectional surfaces perpendicular to the extending direction of the plurality of cells have desired shapes. While a length in the extending direction of the partition wall is not specifically limited, the length is usually approximately the same as the axial length of the honeycomb substrate. A thickness of the partition wall is not specifically limited and a general thickness can be used. For example, the thickness may be in a range of 50 μm or more and 2000 μm or less, and may be in a range of 100 μm or more and 300 μm or less. This is because the thickness of the partition wall in these ranges allows obtaining a sufficient PM trap performance while ensuring a strength of the substrate, and the pressure loss can be sufficiently suppressed.

The partition wall has a porous structure including pores as a pore through which the exhaust gas can pass. A porosity of the partition wall (porosity of the partition wall alone) is not specifically limited and a general porosity can be used. For example, the porosity may be in a range of 40% or more and 70% or less, and may be in a range of 50% or more and 70% or less. This is because the porosity of equal to or more than the lower limits of these ranges allows effectively suppressing the pressure loss, and the porosity of equal to or less than the upper limits of these ranges allows ensuring a sufficient mechanical strength. A mean pore size of the pores of the partition wall (mean pore size of the pores of the partition wall alone) is not specifically limited and a general mean pore size can be used. For example, the mean pore size may be in a range of 1 μm or more and 60 μm or less, and may be in a range of 5 μm or more and 30 μm or less, especially in a range of 5 μm or more and 20 μm or less. This is because the mean pore size of the pores within these ranges allows obtaining the sufficient PM trap performance, and the pressure loss can be sufficiently suppressed. The “mean pore size of the pores of the partition wall” means, for example, one measured by a method of mercury penetration.

The inflow cells and the outflow cells are formed by partitioning the space inside the frame portion with the partition wall, and adjacent across the partition wall. The inflow cells and the outflow cells are usually surrounded by the partition wall in a direction perpendicular to the extending direction.

The inflow cell has the outflow side end usually sealed by the sealing portion. The outflow cell has the inflow side end usually sealed by the sealing portion. A length in the extending direction of the sealing portion is not specifically limited and a general length may be used. For example, the length may be in a range of 2 mm or more and 20 mm or less, and may be in a range of 2 mm or more and 10 mm or less. A material of the sealing portion is not specifically limited and may be a general material.

Cross-sectional shapes perpendicular to the extending direction of the inflow cell and the outflow cell are not specifically limited and general shapes can be used. The cross-sectional shapes can be appropriately configured considering the flow rate, components, and the like of the exhaust gas passing through the exhaust gas purification device. Examples of the cross-sectional shape include a rectangular shape, such as a square, a polygon including a hexagon and the like, and a circular shape. Cross-sectional areas perpendicular to the extending direction of the inflow cell and the outflow cell are not specifically limited and general cross-sectional areas can be used. For example, the cross-sectional areas are in a range of 1 mm² or more and 7 mm² or less. While lengths in the extending direction of the inflow cell and the outflow cell are not specifically limited, the lengths are usually approximately the same as a length found by subtracting the length in the extending direction of the sealing portion from the axial length of the honeycomb substrate. Examples of an arrangement aspect of the inflow cells and the outflow cells include, like the arrangement aspect of the first embodiment, an aspect like a checkered pattern in which the inflow cells and the outflow cells are arranged in alternation.

### 2. Outflow Cell Side Catalyst and Outflow Cell Side Catalyst-Disposed Wall

The outflow cell side catalyst is disposed in the inner region of the partition wall (pores provided in the inner region of the partition wall) on the outflow cell side in the outflow cell side catalyst-disposed range extending from the outflow side end of the partition wall to a position apart from the outflow side end by a predetermined distance along the extending direction. The porosity in the thickness direction of the outflow cell side catalyst-disposed wall including the outflow cell side catalyst-disposed range of the partition wall and the outflow cell side catalyst has the minimum value in a range of 20% or more and 30% or less. The minimum value of the porosity equal to or more than the lower limit of the range enables reduction of the pressure loss, and the minimum value of the porosity equal to or less than the upper limit of the range enables the improvement of the exhaust gas purification performance.

The outflow cell side catalyst-disposed range of the partition wall is not specifically limited insofar as it is a region extending from the outflow side end of the partition wall to a position apart from the outflow side end toward the inflow side along the extending direction by a predetermined distance. For example, as described in the first to the third embodiments, the outflow cell side catalyst-disposed range of the partition wall may be a region extending from the outflow side end of the partition wall to a position apart from the outflow side end toward the inflow side along the extending direction by a distance of 50% or more and 100% or less of the length in the extending direction of the partition wall, may be a region extending to a position apart by a distance of 55% or more and 90% or less of the length in the extending direction of the partition wall, and may be a region extending to a position apart by a distance of 60% or more and 80% or less of the length in the extending direction of the partition wall. This is because the length in the extending direction of the outflow cell side catalyst-disposed range (length in the extending direction of the outflow cell side catalyst) in the range of these distances enables effectively reducing the pressure loss and effectively improving the exhaust gas purification performance.

The outflow cell side catalyst-disposed wall is a wall including the outflow cell side catalyst-disposed range of the partition wall and the outflow cell side catalyst. That is, the outflow cell side catalyst-disposed wall is a catalyst-disposed wall in which the outflow cell side catalyst is disposed in the outflow cell side catalyst-disposed range of the partition wall. The porosity of the outflow cell side catalyst-disposed wall is smaller than the porosity of the partition wall alone by the amount of the outflow cell side catalyst filled in the pores of the partition wall alone.

The “minimum value of the porosity in the thickness direction of the outflow cell side catalyst-disposed wall” means, for example, a minimum value of the porosity in the thickness direction at a reference position in the extending direction of the outflow cell side catalyst-disposed wall. While the reference position of the outflow cell side catalyst-disposed wall is not specifically limited insofar as it is any position in the extending direction of the outflow cell side catalyst-disposed wall, the reference position of the outflow cell side catalyst-disposed wall may be a position close to the outflow side as much as possible in a range not overlapping with the arrangement region of the sealing portion that seals the outflow side end of the inflow cell in the extending direction. This is because the porosity in the thickness direction at such a position has a large influence on the pressure loss and the exhaust gas purification performance, and therefore, the minimum value of the porosity of 20% or more and 30% or less enables effectively reducing the pressure loss and effectively improving the exhaust gas purification performance.

Examples of a method for obtaining the minimum value of the porosity in the thickness direction at the reference position in the extending direction of the outflow cell side catalyst-disposed wall include a method in which the porosity is measured at respective positions in the thickness direction in a reference region of the outflow cell side catalyst-disposed wall while comprising a region between adjacent corners of the inflow cell (outflow cell) in a range of +1 mm in the extending direction from the reference position of the outflow cell side catalyst-disposed wall (however, limited to a range included in the outflow cell side catalyst-disposed wall) as the reference region, and the smallest value in the measurement values of the porosity is obtained as the minimum value of the porosity. The porosity at each position in the thickness direction in the reference region of the outflow cell side catalyst-disposed wall may be, for example, a proportion of an area of the pores in the whole area of the cross section perpendicular to the thickness direction at each position in the thickness direction in the reference region of the outflow cell side catalyst-disposed wall.

The outflow cell side catalyst-disposed wall is not specifically limited insofar as the minimum value of the porosity in the thickness direction at the reference position in the extending direction of the outflow cell side catalyst-disposed wall is in a range of 20% or more and 30% or less. The outflow cell side catalyst-disposed wall may be one having a mean value of the minimum values of the porosity in the thickness direction at a plurality of different calculation positions in the extending direction of the outflow cell side catalyst-disposed wall in a range of 20% or more and 30% or less. This is because the pressure loss can be effectively reduced, and the exhaust gas purification performance can be effectively improved. The plurality of different calculation positions are not specifically limited insofar as they are a plurality of any positions in the extending direction at the outflow cell side catalyst-disposed wall. For example, the plurality of different calculation positions may be a plurality of positions arranged at equal intervals in the extending direction including a position close to the outflow side as much as possible in a range not overlapping with the arrangement region of the sealing portion that seals the outflow side end of the inflow cell in the extending direction and a position at the inflow side end in the extending direction of the outflow cell side catalyst-disposed wall. Examples of a method for obtaining the minimum value of the porosity in the thickness direction at each calculation position in the extending direction of the outflow cell side catalyst-disposed wall include a method in which the porosity is measured at respective positions in the thickness direction in a calculation region of the outflow cell side catalyst-disposed wall while comprising a region between adjacent corners of the inflow cell (outflow cell) in a range of +1 mm in the extending direction from each calculation position of the outflow cell side catalyst-disposed wall (however, limited to a range included in the outflow cell side catalyst-disposed wall) as the calculation region, and the smallest value in the measurement values of the porosity is obtained as the minimum value of the porosity. The porosity at each position in the thickness direction in the calculation region of the outflow cell side catalyst-disposed wall may be, for example, a proportion of an area of the pores in the whole area of the cross section perpendicular to the thickness direction at each position in the thickness direction in the calculation region of the outflow cell side catalyst-disposed wall. Furthermore, the outflow cell side catalyst-disposed wall may be one having a minimum value of the porosity in the thickness direction of the whole outflow cell side catalyst-disposed wall in the extending direction in a range of 20% or more and 30% or less. This is because the pressure loss can be effectively reduced, and the exhaust gas purification performance can be effectively improved. Examples of a method for obtaining the minimum value of the porosity in the thickness direction of the whole outflow cell side catalyst-disposed wall in the extending direction include a method in which the porosity is measured at respective positions in the thickness direction in a calculation region of the whole outflow cell side catalyst-disposed wall in the extending direction while comprising a region between adjacent corners of the inflow cell (outflow cell) of the whole outflow cell side catalyst-disposed wall in the extending direction as the calculation region of the whole outflow cell side catalyst-disposed wall in the extending direction, and the smallest value in the measurement values of the porosity is obtained as the minimum value of the porosity. The porosity at each position in the thickness direction in the calculation region of the whole outflow cell side catalyst-disposed wall in the extending direction may be, for example, a proportion of an area of the pores in the whole area of the cross section perpendicular to the thickness direction at each position in the thickness direction in the calculation region of the whole outflow cell side catalyst-disposed wall in the extending direction.

The outflow cell side catalyst usually includes the catalyst metal particles and the carrier that supports the catalyst metal particles. The outflow cell side catalyst is, for example, a sintered body of a carrier with catalyst supporting the catalyst metal particles on the carrier.

While a material of the catalyst metal particles is not specifically limited and a general material can be used, examples of the material include a catalyst metal such as platinum (Pt), palladium (Pd), and rhodium (Rh). The material of the catalyst metal particles may be one metal or two or more metals, or may be an alloy containing two or more metals. The material of the catalyst metal particles may be rhodium or the like.

While a mean particle size of the catalyst metal particles is not specifically limited and a general mean particle size can be used, the mean particle size may be, for example, in a range of 0.1 nm or more and 20 nm or less. This is because the mean particle size equal to or less than the upper limit of the range allows increasing a contact area with the exhaust gas. The mean particle size of the catalyst metal particles means, for example, an average value obtained from particle sizes measured by a transmission electron microscope (TEM).

While a content of the catalyst metal particles is not specifically limited and a general content can be used, the content differs depending on the material of the catalyst metal particles. For example, when the material is at least one of Pt, Pd, and Rh, the content may be in a range of 0.01 g or more and 2 g or less per liter of the honeycomb substrate. This is because the content equal to or more than the lower limit of the range can provide the sufficient catalytic action, and the content equal to or less than the upper limit of the range can suppress the grain growth of the catalyst metal particles and provide an advantage in the aspect of cost. Here, the content of the catalyst metal particles per liter of the substrate volume means a value obtained by dividing the mass of the catalyst metal particles contained in the outflow cell side catalyst by the volume of a part of the honeycomb substrate in the axial direction having the axial length the same as the length in the extending direction of the outflow cell side catalyst.

While a material of the carrier is not specifically limited, and a general material can be used, examples of the material include a metallic oxide, such as alumina (Al₂O₃), ceria (CeO₂), zirconia (ZrO₂), silica (SiO₂), magnesia (MgO), and titanium oxide (TiO₂), a solid solution such as an alumina-zirconia (Al₂O₃—ZrO₂) composite oxide, and a ceria-zirconia (CeO₂—ZrO₂) composite oxide, or the like. The material of the carrier may be one or two or more among them. The material of the carrier may be at least one of alumina, ceria-zirconia composite oxide, and the like.

While a shape of the carrier is not specifically limited, and a general shape can be used, the carrier may be in powder form. This is because a larger specific surface area can be secured. A mean particle size D50 of the carrier in powder form is not specifically limited, and a general mean particle size can be used. For example, the mean particle size D50 may be in a range of 1 μm or more and 15 μm or less, and may be in a range of 4 μm or more and 10 μm or less. This is because the mean particle size D50 equal to or more than the lower limits of these ranges can provide the sufficient heat resistant property. That is because the mean particle size D50 equal to or less than the upper limits of these ranges sufficiently ensures the dispersibility of the catalyst metal particles, thus allowing effectively improving the purification performance. The mean particle size D50 of the carrier in powder form is obtained by, for example, laser diffraction and scattering, and can be measured using, for example, a laser scattering particle size distribution analyzer LA-960 (manufactured by HORIBA, Ltd.).

A mass ratio of the catalyst metal particles to a total mass of the catalyst metal particles and the carrier is not specifically limited, and a general mass ratio can be used. For example, the mass ratio may be in a range of 0.01 mass % or more and 10 mass % or less. This is because the mass ratio equal to or more than the lower limit of this range can provide the sufficient catalytic action, and the mass ratio equal to or less than the upper limit of this range can suppress the grain growth of the catalyst metal particles and provide an advantage in the aspect of cost.

While a method that causes the carrier to support the catalyst metal particles is not specifically limited, and a general method can be used, examples of the method include a method in which the carrier is immersed in an aqueous solution containing a catalytic metal salt (such as nitrate) or a catalytic metal complex (such as tetraammine complex) and subsequently dried and fired.

The outflow cell side catalyst may include, in addition to the catalyst metal particles and the carrier, for example, a cocatalyst, such as an Oxygen Storage Capacity (OSC) material.

While a material of the cocatalyst is not specifically limited, and a general material can be used, examples of the material include a material similar to the material of the carrier. Especially, examples of the material of the OSC material among the cocatalysts include ceria and a composite oxide containing ceria. Examples of the composite oxide containing ceria include a ceria-zirconia composite oxide. While a shape of the cocatalyst is not specifically limited, and a general shape can be used, examples of the shape include a shape similar to the shape of the carrier. While a mean particle size D50 of the cocatalyst in powder form is not specifically limited, and a general mean particle size can be used, examples of the mean particle size include a mean particle size similar to the mean particle size of the carrier in powder form. A mass ratio of the cocatalyst to a total mass of the catalyst metal particles, the carrier, and the cocatalyst is not specifically limited, and a general mass ratio can be used. For example, the mass ratio may be in a range of 30 mass % or more and 80 mass % or less.

While a density of the outflow cell side catalyst is not specifically limited, for example, the density may be in a range of 5 g/L or more and 100 g/L or less, may be in a range of 10 g/L or more and 65 g/L or less, or may be in a range of 30 g/L or more and 60 g/L or less. This is because the density of the outflow cell side catalyst equal to or more than the lower limits of these ranges allows effectively improving the purification performance. That is because the density of the outflow cell side catalyst equal to or less than the upper limits of these ranges allows effectively suppressing the pressure loss. The “density of the outflow cell side catalyst” means a value obtained by dividing the mass of the outflow cell side catalyst by the volume of a part of the honeycomb substrate in the axial direction having the axial length the same as the length in the extending direction of the outflow cell side catalyst.

While a method for forming the outflow cell side catalyst is not specifically limited, and a general method can be used, examples of the method include a method in which a slurry prepared by mixing the catalyst metal particles and the carrier supporting the catalyst metal particles with a solvent is supplied in the inner region of the partition wall on the outflow cell side in the outflow cell side catalyst-disposed range of the partition wall, and subsequently, the slurry is dried and fired.

In the method in which the slurry is supplied to the partition wall and subsequently, the slurry is dried and fired to form the outflow cell side catalyst, the slurry may contain any given component such as a cocatalyst, a binder, and an additive, as necessary in addition to the catalyst metal particles and the carrier, and the solvent. The mean particle sizes and the like of the solid content, such as the carrier in powder form and the cocatalyst, contained in the slurry may be appropriately adjusted so as to cause the slurry to penetrate into the inner region of the partition wall on the outflow cell side in the outflow cell side catalyst-disposed range of the partition wall.

While the method for preparing the slurry is not specifically limited, and a general method can be used, for example, a method below is included. First, a carrier in powder form is immersed in a solution (such as an aqueous solution) containing a catalytic metal salt or a catalytic metal complex, and subsequently they are dried and fired, thus preparing a catalytic metal supporting powder supporting a catalytic metal. Next, an OSC material, a cocatalyst, a binder, and an ion exchanged water are added to the catalytic metal supporting powder, and they are sufficiently stirred and wet-ground so as to have a desired value of a mean particle size D50 of the solid contents. Thus, the slurry is prepared.

The mean particle size D50 of the solid contents of the slurry is not specifically limited, and a general mean particle size can be used. The mean particle size D50 of the solid contents of the slurry can be measured using, for example, a laser scattering particle size distribution analyzer LA-960 (manufactured by HORIBA, Ltd.).

The method for supplying the slurry to the inner region of the partition wall on the outflow cell side in the outflow cell side catalyst-disposed range of the partition wall is not specifically limited, and a general method can be used. Examples of the method include a method in which the honeycomb substrate is immersed in the slurry from the outflow side and taken out from the slurry after the elapse of a predetermined period. In this method, the properties of the slurry, such as a solid content concentration and a viscosity, may be adjusted as necessary so as to supply the slurry to the inner region of the partition wall on the outflow cell side in the outflow cell side catalyst-disposed range of the partition wall. As the method for supplying the slurry to the inner region of the partition wall on the outflow cell side in the outflow cell side catalyst-disposed range of the partition wall, a method in which the slurry is blown off using a blower so as not to supply the slurry to unnecessary parts of the catalyst in the inner region and on the surface of the partition wall when the slurry is supplied may be used.

In the method in which the slurry is dried and fired after the slurry is supplied to the partition wall, the drying condition is not specifically limited. While the drying condition depends on the shapes, the dimensions, and the like of the honeycomb substrate, the carrier, and the like, the drying condition may be a condition, for example, in which the drying is performed at a temperature in a range of 80° C. or more and 300° C. or less for a period in a range of one hour or more and 10 hours or less. While the firing condition is not specifically limited, for example, the firing condition may be a condition in which the firing is performed at a temperature in a range of 400° C. or more and 1000° C. or less for a period in a range of one hour or more and four hours or less.

The properties and the like, for example, the minimum value of the porosity in the thickness direction of the outflow cell side catalyst-disposed wall, the thickness of the outflow cell side catalyst, and the porosity of the outflow cell side catalyst, can be adjusted by, for example, a method of adjusting the mean particle size D50 of the solid content of the slurry, the solid content concentration of the slurry, the property of the slurry, the supply amount of the slurry, the drying condition, the firing condition, and the like.

### 3. Exhaust Gas Purification Device

The exhaust gas purification device includes the honeycomb substrate and the outflow cell side catalyst. The exhaust gas purification device usually further includes sealing portions sealing outflow side ends of the inflow cells and sealing portions sealing inflow side ends of the outflow cells.

### (1) Inflow Cell Side Catalyst

The exhaust gas purification device may further include an inflow cell side catalyst disposed in the inflow cell side catalyst-disposed range extending from the inflow side end of the partition wall to a position apart from the inflow side end by a predetermined distance along the extending direction as described in the first and the second embodiments, and may be one without the inflow cell side catalyst as described in the third embodiment. In the exhaust gas purification device, regardless of whether the inflow cell side catalyst is provided or not, whether or not the exhaust gas is hindered from passing through at the neck portion when the exhaust gas pass through the outflow cell side catalyst-disposed wall from the inflow cell side to the outflow cell side in the thickness direction has a large influence on the pressure loss. Furthermore, regardless of whether the inflow cell side catalyst is provided or not, the amount of the outflow cell side catalyst disposed at the outflow cell side catalyst-disposed wall has an influence on the exhaust gas purification performance. Accordingly, regardless of whether the inflow cell side catalyst is provided or not, an effect of enabling reduction of the pressure loss and enabling improvement of the exhaust gas purification performance can be provided.

The inflow cell side catalyst is disposed at least one of on the partition wall surface on the inflow cell side and in the inner region of the partition wall (pores provided in the inner region) on the inflow cell side in the inflow cell side catalyst-disposed range of the partition wall.

The inflow cell side catalyst-disposed range of the partition wall is not specifically limited insofar as the region extends from the inflow side end of the partition wall to the position apart from the inflow side end toward the outflow side by a predetermined distance along the extending direction. For example, the inflow cell side catalyst-disposed range may be a region extending to a position overlapping with the outflow cell side catalyst-disposed range along the extending direction and extending from the inflow side end of the partition wall to a position apart from the inflow side end toward the outlet side by a distance of 80% or less of the length in the extending direction of the partition wall along the extending direction. This is because with the inflow cell side catalyst-disposed range extending to the position overlapping with the outflow cell side catalyst-disposed range, it can be suppressed that the exhaust gas transmits through a region of the partition wall in which the catalyst is not disposed and is discharged from the exhaust gas purification device without being purified. Further, this is because the length in the extending direction of the inflow cell side catalyst-disposed range (length in the extending direction of the inflow cell side catalyst) is 80% or less of the length in the extending direction of the partition wall, and this allows suppressing the increase of the pressure loss.

The inflow cell side catalyst usually includes catalyst metal particles and a carrier supporting the catalyst metal particles. The inflow cell side catalyst is, for example, a sintered body including a carrier with catalyst in which the catalyst metal particles are supported by the carrier.

A material of the catalyst metal particles is similar to the material of the catalyst metal particles included in the outflow cell side catalyst except that at least one of platinum, palladium, and the like may be used. A mean particle size of the catalyst metal particles is similar to that of the catalyst metal particles included in the outflow cell side catalyst.

While a content of the catalyst metal particles is not specifically limited and a general content can be used, the content differs depending on the material of the catalyst metal particles. For example, when the material is at least one of Pt, Pd, and Rh, the content may be in a range of 0.05 g or more and 5 g or less per liter of the honeycomb substrate. This is because the content equal to or more than the lower limit of the range can provide the sufficient catalytic action, and the content equal to or less than the upper limit of the range can suppress the grain growth of the catalyst metal particles and provide an advantage in the aspect of cost. Here, the content of the catalyst metal particles per liter of the substrate volume means a value obtained by dividing the mass of the catalyst metal particles contained in the inflow cell side catalyst by the volume of a part of the honeycomb substrate in the axial direction having the axial length the same as the length in the extending direction of the inflow cell side catalyst.

A material and a shape of the carrier are similar to those of the carrier included in the outflow cell side catalyst. A mean particle size D50 of the carrier in powder form is not specifically limited, and a general mean particle size can be used. A mass ratio of the catalyst metal particles to a total mass of the catalyst metal particles and the carrier is similar to the mass ratio in the outflow cell side catalyst. A method that causes the carrier to support the catalyst metal particles is similar to the method in the outflow cell side catalyst. The inflow cell side catalyst may include a cocatalyst and the like similarly to the outflow cell side catalyst. The cocatalyst is similar to the cocatalyst included in the outflow cell side catalyst.

While a density of the inflow cell side catalyst is not specifically limited, for example, the density may be in a range of 5 g/L or more and 100 g/L or less, may be in a range of 10 g/L or more and 65 g/L or less, and may be in a range of 10 g/L or more and 30 g/L or less. This is because the density of the inflow cell side catalyst equal to or more than the lower limits of these ranges allows more effectively purifying the exhaust gas by the inflow cell side catalyst. Further, this is because the density of the inflow cell side catalyst equal to or less than the upper limits of these ranges allows effectively suppressing increase of the pressure loss. The “density of the inflow cell side catalyst” means a value obtained by dividing the mass of the inflow cell side catalyst by the volume of a part of the honeycomb substrate in the axial direction having the axial length the same as the length in the extending direction of the inflow cell side catalyst.

While a method for forming the inflow cell side catalyst is not specifically limited, and a general method can be used, examples of the method include a method in which a slurry prepared by mixing the catalyst metal particles and the carrier supporting the catalyst metal particles with a solvent is supplied at least one of on the partition wall surface on the inflow cell side and in the inner region of the partition wall on the inflow cell side in the inflow cell side catalyst-disposed range of the partition wall, and subsequently, the slurry is dried and fired.

In the method in which the slurry is supplied to the partition wall and subsequently, the slurry is dried and fired to form the inflow cell side catalyst, the slurry may contain any given component such as a cocatalyst, a binder, and an additive, as necessary in addition to the catalyst metal particles and the carrier, and the solvent. The mean particle sizes and the like of the solid content, such as the carrier in powder form and the cocatalyst, contained in the slurry may be appropriately adjusted so as to cause the slurry not to penetrate into the inner region of the partition wall when the inflow cell side catalyst is formed mainly on the partition wall surface on the inflow cell side of the partition wall, for example, as described in the first embodiment. For example, when the inflow cell side catalyst is formed mainly in the inner region of the partition wall on the inflow cell side of the partition wall as described in the second embodiment, the adjustment may be appropriately performed so as to cause the slurry to penetrate into the inner region of the partition wall. The method for preparing the slurry is similar to the method for preparing the slurry used in the formation of the outflow cell side catalyst. The mean particle size D50 of the solid content of the slurry is not specifically limited, and a general mean particle size can be used.

The method for supplying the slurry at least one of on the partition wall surface on the inflow cell side and in the inner region of the partition wall on the inflow cell side in the inflow cell side catalyst-disposed range of the partition wall is not specifically limited, and a general method can be used. Examples of the method include a method in which the honeycomb substrate is immersed in the slurry from the inflow side and taken out from the slurry after the elapse of a predetermined period. In this method, for example, when the inflow cell side catalyst is formed mainly on the partition wall surface on the inflow cell side of the partition wall, the properties of the slurry, such as a solid content concentration and a viscosity, may be adjusted as necessary so as not to supply the slurry in the inner region of the partition wall, or a pressure may be applied to the outflow cell from the outflow side to generate a pressure difference between the outflow cell and the inflow cell. For example, when the inflow cell side catalyst is formed mainly in the inner region of the partition wall on the inflow cell side of the partition wall, the properties of the slurry, such as a solid content concentration and a viscosity, may be adjusted as necessary so as to supply the slurry in the inner region of the partition wall on the inflow cell side of the partition wall. Furthermore, as the method for supplying the slurry at least one of on the partition wall surface on the inflow cell side and in the inner region of the partition wall on the inflow cell side in the inflow cell side catalyst-disposed range of the partition wall, a method in which the slurry is blown off using a blower so as not to supply the slurry to unnecessary parts of the catalyst on the partition wall surface and in the inner region of the partition wall when the slurry is supplied may be used.

The drying condition and the firing condition in the method in which the slurry is dried and fired after the slurry is supplied to the partition wall are similar to the drying condition and the firing condition used in the formation of the outflow cell side catalyst.

The properties, such as a thickness of the inflow cell side catalyst and a porosity of the inflow cell side catalyst, the porosity of the inflow cell side catalyst-disposed wall including the inflow cell side catalyst-disposed range of the partition wall and the inflow cell side catalyst, and the like can be adjusted by, for example, a method of adjusting the mean particle size D50 of the solid content of the slurry, the solid content concentration of the slurry, the property of the slurry, the supply amount of the slurry, the drying condition, the firing condition, and the like.

### (2) Others

When the exhaust gas purification device further includes the inflow cell side catalyst, as described in the first embodiment, in the exhaust gas purification device, the catalyst metal particles included in the inflow cell side catalyst may contain at least one of platinum (Pt) and palladium (Pd), and the catalyst metal particles included in the outflow cell side catalyst may contain rhodium (Rh). This is because since the exhaust gas is brought in contact with the outflow cell side catalyst after hydrocarbon (HC) included in the exhaust gas is effectively converted by the catalyst metal particles included in the inflow cell side catalyst, poisoning of rhodium (Rh) contained in the catalyst metal particles included in the outflow cell side catalyst by hydrocarbon (HC) can be suppressed.

### EXAMPLES

The following further specifically describes the exhaust gas purification device according to the embodiment with examples and comparative examples.

### Example 1

An example of the exhaust gas purification device according to the first embodiment was produced. Specifically, first, a GPF in which the honeycomb substrate 10 and the sealing portion 16 were provided and the catalyst was not provided was prepared. Details of the configurations of the honeycomb substrate 10 and the sealing portion 16 of the GPF are as follows.

### (Configuration of Honeycomb Substrate and Sealing Portion)

Material of Honeycomb Substrate: Cordierite
Size of Honeycomb Substrate: Outer Diameter×Axial Length=117 mm×122 mm
Thickness of Partition Wall: 240 μm
Porosity of Partition Wall (Porosity of Partition Wall Alone): 61%
Mean Pore Size of Pores in Partition wall (Mean Pore Size of Pores in Partition Wall Alone): 7 μm
Cell Density: 200 per square inch
Length in Extending Direction of Sealing Portion: 5 mm

Next, a carrier with catalyst in which catalyst metal particles were supported by a carrier in powder form was mixed with a solvent, thus preparing a slurry for inflow cell side catalyst. Specifically, alumina in powder form (carrier) was immersed in an aqueous solution containing Pt nitrate (catalytic metal salt), and subsequently, they were dried and fired, thus preparing a Pt supporting powder supporting platinum (Pt) on alumina in powder form. Next, a ceria-zirconia complex oxide (OSC material), barium sulfate (cocatalyst), a binder, and an ion exchanged water (solvent) were added to the Pt supporting powder, and they were sufficiently stirred and wet-ground. Thus, the slurry for inflow cell side catalyst was prepared.

Next, the slurry for inflow cell side catalyst was poured into the inflow cell 12A from the inflow side end 12Aa, thereby supplying the slurry for inflow cell side catalyst on the partition wall surface 14SA on the inflow cell 12A side in the inflow cell side catalyst-disposed range 14X of the partition wall 14. At this time, the supply amount of the slurry was adjusted to obtain a desired value of the density of the inflow cell side catalyst 20. The inflow cell side catalyst-disposed range 14X of the partition wall 14 is a region extending from the inflow side end 14a of the partition wall 14 to the position 14b apart from the inflow side end 14a toward the outflow side by a distance of 50% of the length in the extending direction of the partition wall 14 along the extending direction. Subsequently, the honeycomb substrate 10 to which the slurry for inflow cell side catalyst was supplied was dried by heating at 120° C. for two hours using a dryer to remove water content, and subsequently, the honeycomb substrate 10 was fired at 500° C. for two hours using an electric furnace. Thus, the inflow cell side catalyst 20 was formed.

Next, a carrier with catalyst in which catalyst metal particles were supported by a carrier in powder form was mixed with a solvent, thus preparing a slurry for outflow cell side catalyst. Specifically, a ceria-zirconia complex oxide (carrier) in powder form was immersed in an aqueous solution containing Rh nitrate (catalytic metal salt), and subsequently, they were dried and fired, thus preparing a Rh supporting powder supporting rhodium (Rh) on the ceria-zirconia complex oxide in powder form. Next, the ceria-zirconia complex oxide (OSC material), alumina (cocatalyst), a binder, and an ion exchanged water (solvent) were added to the Rh supporting powder, and they were sufficiently stirred and wet-ground. Thus, the slurry for outflow cell side catalyst was prepared.

Next, the slurry for outflow cell side catalyst was poured into the outflow cell 12B from the outflow side end 12Bb, thereby supplying the slurry for outflow cell side catalyst to the inner region of the partition wall 14NB on the outflow cell 12B side in the outflow cell side catalyst-disposed range 14Y of the partition wall 14. The outflow cell side catalyst-disposed range 14Y of the partition wall 14 is a region extending from the outflow side end 14d of the partition wall 14 to the position 14e apart from the outflow side end 14d toward the inflow side by a distance of 70% of the length in the extending direction of the partition wall 14 along the extending direction. Subsequently, the honeycomb substrate 10 to which the slurry for outflow cell side catalyst was supplied was dried by heating at 120° C. for two hours using a dryer to remove water content, and subsequently, the honeycomb substrate 10 was fired at 500° C. for two hours using an electric furnace. Thus, the outflow cell side catalyst 30 was formed.

As described above, as illustrated in FIG. 2, the exhaust gas purification device 1 that includes the honeycomb substrate 10, the sealing portions 16, the inflow cell side catalyst 20, and the outflow cell side catalyst 30 was produced. The density of the outflow cell side catalyst 30 was 49 g/L.

### Example 2

The exhaust gas purification device 1 was produced with the producing method similar to that of Example 1 except that when the slurry for outflow cell side catalyst was supplied to the inner region of the partition wall 14NB on the outflow cell 12B side in the outflow cell side catalyst-disposed range 14Y of the partition wall 14, the supply amount of the slurry for outflow cell side catalyst was adjusted to obtain 39 g/L of the density of the outflow cell side catalyst 30.

### Comparative Example 1

The exhaust gas purification device 1 was produced with the producing method similar to that of Example 1 except that when the slurry for outflow cell side catalyst was supplied to the inner region of the partition wall 14NB on the outflow cell 12B side in the outflow cell side catalyst-disposed range 14Y of the partition wall 14, the supply amount of the slurry for outflow cell side catalyst was adjusted to obtain 109 g/L of the density of the outflow cell side catalyst 30.

### Comparative Example 2

The exhaust gas purification device 1 was produced with the producing method similar to that of Example 1 except that when the slurry for outflow cell side catalyst was supplied to the inner region of the partition wall 14NB at the outflow cell 12B side in the outflow cell side catalyst-disposed range 14Y of the partition wall 14, the supply amount of the slurry for outflow cell side catalyst was adjusted to obtain 94 g/L of the density of the outflow cell side catalyst 30.

### Comparative Example 3

The exhaust gas purification device 1 was produced with the producing method similar to that of Example 1 except that when the slurry for outflow cell side catalyst was supplied to the inner region of the partition wall 14NB at the outflow cell 12B side in the outflow cell side catalyst-disposed range 14Y of the partition wall 14, the supply amount of the slurry for outflow cell side catalyst was adjusted to obtain 79 g/L of the density of the outflow cell side catalyst 30.

### Comparative Example 4

The exhaust gas purification device 1 was produced with the producing method similar to that of Example 1 except that the outflow cell side catalyst 30 was not formed.

### [Evaluation]

For the exhaust gas purification devices 1 produced in Examples 1 and 2, and Comparative Examples 1 to 4, the cross section perpendicular to the extending direction at the reference position 14c of the outflow cell side catalyst-disposed wall was observed, and an initial pressure loss and the exhaust gas purification performance after a durability test relative to the minimum value of the porosity in the thickness direction at the reference position 14c in the extending direction of the outflow cell side catalyst-disposed wall were evaluated. The outflow cell side catalyst-disposed wall is a wall including the outflow cell side catalyst-disposed range 14Y of the partition wall 14 and the outflow cell side catalyst 30. The reference position 14c in the extending direction of the outflow cell side catalyst-disposed wall is a position apart from the outflow side end 14d of the partition wall 14 toward the inflow side by a distance of 15 mm along the extending direction (position in the outflow side in a range not overlapping with the arrangement region of the sealing portion 16 in the extending direction).

### (Cross Section Observation)

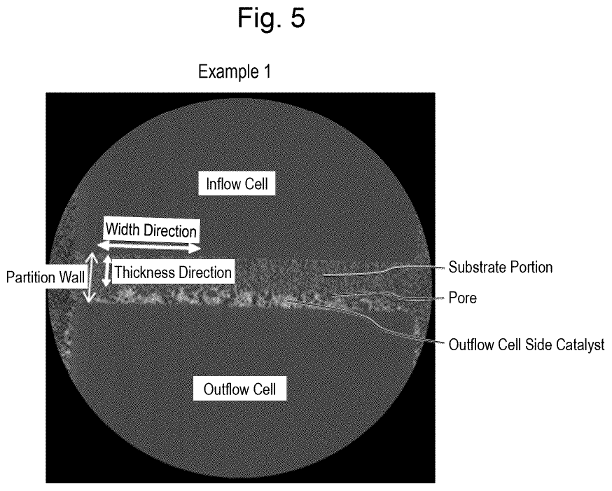

In the exhaust gas purification devices 1 of Examples 1 and 2, and Comparative Examples 1 to 4, a region between adjacent corners of the inflow cell 12A (outflow cell 12B) in a cross section perpendicular to the extending direction at the reference position 14c of the outflow cell side catalyst-disposed wall was photographed by X-ray CT. FIG. 5 is a cross-sectional image by X-ray CT indicating a region between adjacent corners of an inflow cell in a cross section perpendicular to an extending direction at a reference position of an outflow cell side catalyst-disposed wall according to an exhaust gas purification device of Example 1. In this image, the regions of the partition wall 14, the inflow cell 12A, and the outflow cell 12B, the pores in the outflow cell side catalyst-disposed wall (portions in which the outflow cell side catalyst is not filled among the pores of the partition wall alone), the substrate portion of the partition wall 14, and the outflow cell side catalyst 30 are illustrated.

### (Minimum Value of Porosity in Thickness Direction at Reference Position of Outflow Cell Side Catalyst-Disposed Wall)

In the exhaust gas purification devices 1 of Examples 1 and 2, and Comparative Examples 1 to 4, the minimum value of the porosity in the thickness direction at the reference position 14c in the extending direction of the outflow cell side catalyst-disposed wall (minimum value of the porosity in the thickness direction of the outflow cell side catalyst-disposed wall) was obtained.

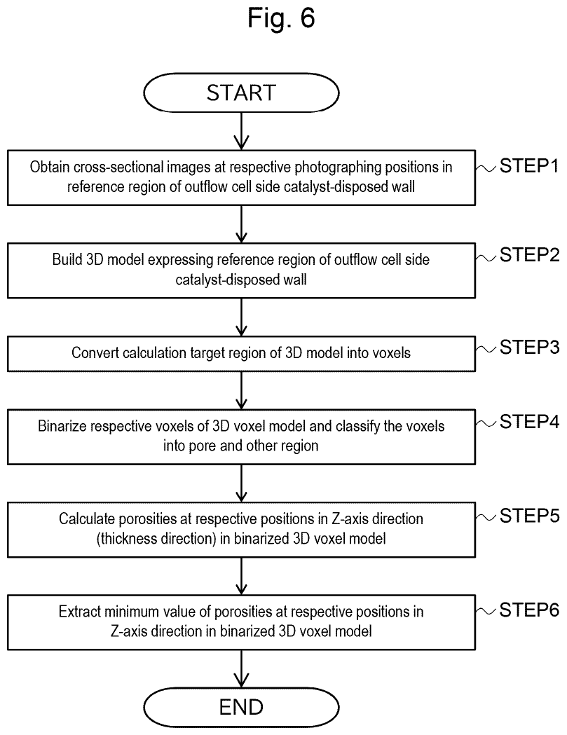

The following describes a procedure of obtaining the minimum value of the porosity in the thickness direction at the reference position 14c in the extending direction of the outflow cell side catalyst-disposed wall in the exhaust gas purification device 1 of each example. FIG. 6 is a flowchart illustrating a procedure of obtaining a minimum value of a porosity in a thickness direction at the reference position in the extending direction of the outflow cell side catalyst-disposed wall.

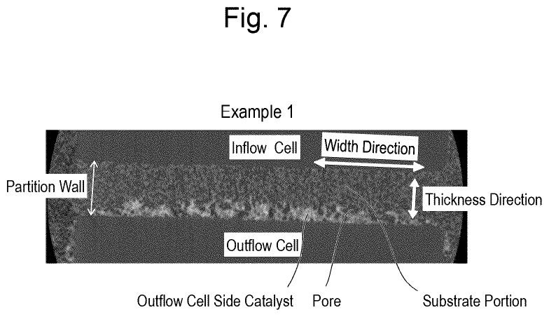

In the procedure, as illustrated in FIG. 6, first, a region between adjacent corners of the inflow cell 12A (outflow cell 12B) in a range of +1 mm in the extending direction from the reference position 14c of the outflow cell side catalyst-disposed wall was defined as the reference region, and cross sections perpendicular to the extending direction were photographed by X-ray CT at 1000 photographing positions set at intervals of 2 μm in the extending direction in the reference region of the outflow cell side catalyst-disposed wall, thus obtaining 1000 cross-sectional images (STEP 1). Specifically, the cross sections perpendicular to the extending direction at the respective photographing positions in the reference region of the outflow cell side catalyst-disposed wall were photographed at 150× magnification, and each cross-sectional image was obtained in 8-bit format of 1280×960 pixels. FIG. 7 is a cross-sectional image indicating a cross section perpendicular to the extending direction at one photographing position (reference position) in a reference region of the outflow cell side catalyst-disposed wall according to the exhaust gas purification device of Example 1.

Subsequently, as illustrated in FIG. 6, using CAE software GEODICT (registered trademark) produced by Math2Market GmbH, the 1000 cross-sectional images were all loaded and the 1000 cross-sectional images were integrated using Import Geo module of GEODICT, thereby building a 3D (three-dimensional) model expressing the reference region of the outflow cell side catalyst-disposed wall (STEP 2). At this time, the 1000 cross-sectional images were loaded and integrated according to the specification of Import Geo module.

Subsequently, as illustrated in FIG. 6, using GEODICT, a calculation target region at the center in the extending direction and the width direction was cut out from the 3D model and converted into voxels, thereby obtaining a 3D voxel model (STEP 3). At this time, a three-dimensional space having the width direction in the X-axis direction, the extending direction in the Y-axis direction, and the thickness direction in the Z-axis direction was employed, and the calculation target region of the 3D model was expressed by voxels arranged in the X-axis direction, the Y-axis direction, and the Z-axis direction, thus obtaining the 3D voxel model.

Subsequently, as illustrated in FIG. 6, using Threshold menu of PoroDict module of GEODICT, by a mode method, a threshold in binarizing each voxel of the 3D voxel model was set to a predetermined value, and then each voxel of the 3D voxel model was binarized, thereby classifying the voxels of the 3D voxel model into the pore in the outflow cell side catalyst-disposed wall and the other region (the substrate portion of the partition wall 14 and the outflow cell side catalyst 30) (STEP 4).

Subsequently, as illustrated in FIG. 6, using 1D statistics menu of PoroDict module of GEODICT, parameters (Input Map) were set as indicated in Table 1 below, and the porosities at respective positions in the Z-axis direction (thickness direction) in the binarized 3D voxel model were calculated (STEP 5). Thus calculated porosities at respective positions in the Z-axis direction in the binarized 3D voxel model were obtained as the porosities at respective positions in the thickness direction in the reference region of the outflow cell side catalyst-disposed wall.

TABLE 1

| Parameter | Set Value |
|---|---|
| BackgroundMode | Pore |
| DirectionX | false |
| DirectionY | false |
| DirectionZ | true |
| AnalyzeLayerThickness | false |
| ResultFileName | 1Dstatistics.gdr |
| Method | 3 |
| WriteFile | false |

Subsequently, as illustrated in FIG. 6, using Excel (registered trademark) produced by Microsoft Corporation, a minimum value of the porosities at the respective positions in the Z-axis direction in the binarized 3D voxel model was extracted (STEP 6). Thus extracted minimum value of the porosities (minimum value of the porosities at the respective positions in the thickness direction in the reference region of the outflow cell side catalyst-disposed wall) were obtained as the minimum value of the porosity in the thickness direction at the reference position 14c in the extending direction of the outflow cell side catalyst-disposed wall.

Table 2 below indicates the minimum value of the porosity in the thickness direction at the reference position 14c in the extending direction of the outflow cell side catalyst-disposed wall obtained for the exhaust gas purification devices 1 of Examples 1 and 2, and Comparative Examples 1 to 4 through the above-described procedure.

### (Initial Pressure Loss)

For the exhaust gas purification devices 1 of Examples 1 and 2, and Comparative Examples 1 to 4, the initial pressure loss at the reference position 14c in the extending direction of the outflow cell side catalyst-disposed wall was calculated. Specifically, using FilterDict module of software GEODICT produced by Math2Market GmbH, as the initial pressure loss at the reference position 14c in the extending direction of the outflow cell side catalyst-disposed wall, a pressure loss when air was flowed through the exhaust gas purification device 1 of each example at 0.01 m/s and 226.85° C. was calculated. Table 2 below indicates the initial pressure loss in each example.

(Exhaust Gas Purification Performance after Durability Test)

For the exhaust gas purification devices 1 of Examples 1 and 2, and Comparative Examples 1 to 4, as an index of the exhaust gas purification performance after a durability test, a highest NOx conversion rate was measured. Specifically, first, the exhaust gas purification device of each example was mounted to an exhaust system of a V-type eight-cylinder engine, exhaust gases in respective stoichiometric and lean atmospheres were repeatedly flowed for a certain period of time (a ratio of 3:1) at a catalyst bed temperature of 900° C. for 50 hours, thus performing the durability test. Subsequently, the exhaust gas purification device of each example after the durability test was mounted to an exhaust system of an L-type four-cylinder engine, an exhaust gas with A/F (air-fuel ratio) of 14.4 was supplied to increase an inlet gas temperature from 200° C. to 600° C. (20° C./minute) under the condition of Ga=28 g/s. In the temperature increase process of the inlet gas temperature, NOx concentrations of an inlet gas and an outlet gas were measured to calculate the NOx conversion rate, and a highest value of the NOx conversion rate was obtained as the highest NOx conversion rate. Table 2 below indicates the highest NOx conversion rate in each example.

TABLE 2

| | | Minimum value of porosity in | Initial pressure loss at | |
|---|---|---|---|---|
| | Density of | thickness direction at | reference position of | |
| | outflow cell | reference position of outflow | outflow cell side | Highest NOx |
| | side catalyst | cell side catalyst-disposed wall | catalyst-disposed wall | conversion rate |
| | [g/L] | [%] | [Pa] | [%] |
| Example 1 | 49 | 23 | 119 | 97.3 |
| Example 2 | 39 | 30 | 66 | 98.1 |
| Comparative Example 1 | 109 | 5.6 | 738 | 95.7 |
| Comparative Example 2 | 94 | 13 | 317 | 99.2 |
| Comparative Example 3 | 79 | 15 | 228 | 99.5 |
| Comparative Example 4 | 0 | 59(*) | 37 | — |

(*)Minimum value of porosity in thickness direction at same position as reference position of partition wall

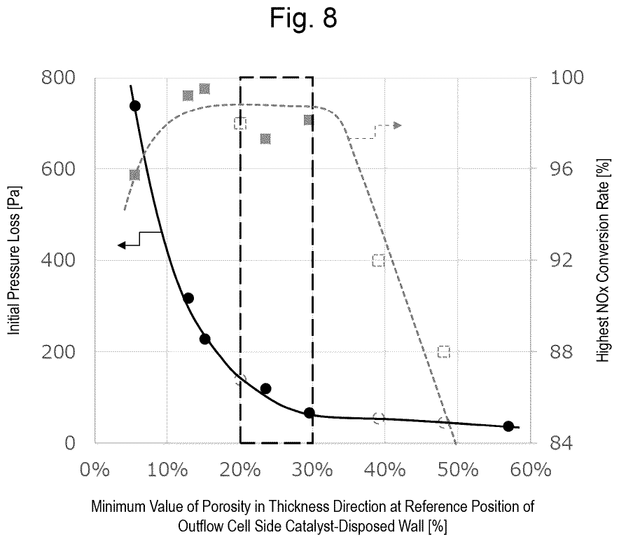

FIG. 8 is a graph illustrating a relation of an initial pressure loss and a highest NOx conversion rate to the minimum value of the porosity in the thickness direction at the reference position in the extending direction of the outflow cell side catalyst-disposed wall obtained in exhaust gas purification devices of Examples 1 and 2, and Comparative Examples 1 to 4. As illustrated in Table 2 and FIG. 8, while the initial pressure loss rapidly increases when the minimum value of the porosity in the thickness direction at the reference position in the extending direction of the outflow cell side catalyst-disposed wall is less than 20%, the increase of the initial pressure loss is suppressed when the minimum value of the porosity is 20% or more. On the other hand, while the highest NOx conversion rate tends to decrease when the minimum value of the porosity exceeds 20% and further increases, the highest NOx conversion rate becomes high when the minimum value of the porosity is 20% or more and 30% or less.

The embodiments of the exhaust gas purification device of the present disclosure have been described above. However, the present disclosure is not limited to the above-described embodiments, and various kinds of changes in design can be made without departing from the spirit of the present disclosure described in the claims.

All publications, patents and patent applications cited in the present description are herein incorporated by reference as they are.

### DESCRIPTION OF SYMBOLS

1 Exhaust gas purification device
10 Honeycomb substrate
10Sa Inflow side end surface
10Sb Outflow side end surface
11 Frame portion
12 Cell
12A Inflow cell
12Aa Inflow side end
12Ab Outflow side end
12B Outflow cell
12Ba Inflow side end
12Bb Outflow side end
14 Partition wall
14a Inflow side end
14b Position apart from inflow side end by predetermined distance along extending direction
14c Reference position in extending direction of outflow cell side catalyst-disposed wall
14d Outflow side end
14e Position apart from outflow side end by predetermined distance along extending direction
14X Inflow cell side catalyst-disposed range
14Y Outflow cell side catalyst-disposed range
14SA Partition wall surface on inflow cell side
14NA Inner region of Partition wall on inflow cell side
14SB Partition wall surface on outflow cell side
14NB Inner region of Partition wall on outflow cell side
16 Sealing portion
20 Inflow cell side catalyst
30 Outflow cell side catalyst

What is claimed is:

1. An exhaust gas purification device comprising:
a honeycomb substrate; and
an outflow cell side catalyst,
wherein the honeycomb substrate includes a porous partition wall that defines a plurality of cells extending from an inflow side end surface to an outflow side end surface,
wherein the plurality of cells include an inflow cell and an outflow cell adjacent across the partition wall,
wherein the inflow cell has an open inflow side end and a sealed outflow side end,
wherein the outflow cell has a sealed inflow side end and an open outflow side end,
wherein the outflow cell side catalyst is disposed in an inner region of the partition wall on the outflow cell side in an outflow cell side catalyst-disposed range extending from an outflow side end of the partition wall to a position apart from the outflow side end by a predetermined distance along an extending direction of the partition wall, and
wherein a minimum value of a porosity in a thickness direction of an outflow cell side catalyst-disposed wall including the outflow cell side catalyst-disposed range of the partition wall and the outflow cell side catalyst is in a range of 20% or more and 30% or less.
